(19) United States
(12) Patent Application Publication
(10) Pub. No.: US 2019/0143527 A1
(43) Pub. Date: May 16, 2019

(54) MULTIPLE INTERACTIVE PERSONALITIES ROBOT

(71) Applicant: TAECHYON ROBOTICS CORPORATION, Sacramento, CA (US)

(72) Inventors: Stephen Favis, Sacramento, CA (US); Deepak Srivastava, San Jose, CA (US)

(21) Appl. No.: 16/096,402

(22) PCT Filed: Apr. 25, 2017
(86) PCT No.: PCT/US2017/029385

§ 371 Date: Oct. 25, 2018

Related U.S. Application Data
(60) Provisional application No. 62/327,934, filed on Apr. 26, 2016.

(51) Int. Cl. B25J 11/00; B25J 13/00

(52) U.S. Cl. CPC B25J 11/001; B25J 13/003; B25J 11/0015

(57) ABSTRACT

Methods and systems are provided to generate and exhibit multiple interactive personalities (MIP) in a robot capable of switching back and forth between the MIP (e.g., synthesized digital voice representing a robot personality, digitally recorded human voice representing a human personality) during a continuing interaction with a user, a group of users, or other robots depending upon the situation. The MIP of the robot are exhibited by the robot speaking in more than one voice type, accent, and emotion accompanied with a suitable facial expression. Corresponding animated multiple interactive personality (AMIP) chat-bot and chatter-bot software is also provided which uses a web/mobile interface to train the MIP using crowd-sourcing methods for a group of users and customization for an individual user. Trained MIPs are downloadable into the MIP robot, AMIP chat-bot and/or AMIP chatter-bot for uses including entertainment, social companionship, education and training, and customer service applications.

### CROSS-REFERENCE TO RELATED APPLICATION

This application claims priority to and the benefit of U.S. Provisional Patent Application No. 62/327,934, filed Apr. 26, 2016, the entire disclosure of which is hereby incorporated by reference herein.

### BACKGROUND OF THE INVENTION

### 1. Field of the Invention

The present invention relates generally to the field of robots; and specifically to the robots that interact with human users on a regular basis and are called social robots. The present invention also includes software based personalities of robots capable of interacting with user, through internet or mobile connected web- or mobile devices, and are called chat-bots or chatter-bots.

### 2. Background

Traditionally, robots have been developed and deployed for last few decades in a variety of industrial production, packaging, shipping and delivery, defense, healthcare, and agriculture areas with a focus on replacing many of the repetitive tasks and communications in pre-determined scenarios. The robotic systems perform the same tasks with a degree of automation. With advances in artificial intelligence and machine learning capabilities in recent years, robots have started to move out of commercial, industrial and lab-level pre-determined scenarios to the interaction, communication, and even co-working with human users in a variety of application areas.

Social robots are being proposed and developed for robot systems and their purely software counterparts including robotic chat- or chatter-bots to interact and communicate with human users in a variety of application areas such as child and elderly care, receptionist, greeter, and guide applications, and multiple-capability home assistant etc. Their software based counter parts are created to perform written (chat) or spoken verbal (chatter) communication with human users called—chat-bots or chatter-bots, respectively. These are traditionally based on multitude of software such as Eliza in the beginning and A.L.I.C.E (based of AIML—Artificial Intelligent Markup Language) recently, which is available on open-source. In addition to advance communication capabilities with human users, social robots also possess whole suite of on-board sensors, actuators, controllers, storage, logic and processing capabilities needed to perform many of the typical robot like mechanical, search, analysis, and response functionalities during interactions with a human user or group of users.

The personality of a robot interacting with a human user with typical robot like characteristics and functions has become important as robotic applications have moved increasingly closer to human users on a regular basis. The personality of a robot is referred to as the knowledge database accessible and a set of rules through which robot choose to respond, communicate, and interact with a user or a group of users. Watson, Siri, Pepper, Buddy, Jibo, and Echo are few prominent examples of such human interfacing social chat-bots, chatter-bots and robots which respond in typical robot like personality traits. The term multiple personalities in robots have been referred to for a central computer based robot management system in a client-server model to manage characteristics or personalities of many chat-bots or robots at the same time. Architecturally, this makes it easier to upload, distribute, or manage personalities in many robots at the same time and communications between many robots are also possible. Furthermore, recently along similar lines, a remote cloud-based architectural management system has also been proposed where many personality types of a robotic system could be developed, modified, updated, uploaded, downloaded, or stored efficiently using cloud computing capabilities. The sense of more than one personality types in a robot based on stored data and set of rules can be chosen by the robot or by a user depending upon the circumstances related to a user or representing mood of the user. The idea of a cloud computing based architecture or capabilities is to make it facile to store, distribute, modify, and manage such multiple personalities.

There are no robots or robotic systems capable of exhibiting Multiple Interacting Personalities (MIP) or their software version Animated Multiple Interacting Personalities (AMIP) chat- and chatter-bots which could include both robot like personality traits expressed in one voice and “inner-human like” personality traits in another voice with accompanying suitable facial expressions capable of switching back and forth during a continuing interaction or communication with a user. The method, systems, and applications of MIP and AMIP type robots, chat- and chatter-bot are presented in this invention disclosure.

### SUMMARY OF THE INVENTION

The object of the present invention disclosure is to provide a method and system for a robot to create and show Multiple Interactive Personalities (MIP) capable of switching back and forth during a continuing interaction or communication with a user depending upon the situation. Specifically, the MIPs in a robot are exhibited by the robot capable of speaking in more than one voice type, accent, and emotions accompanied with suitable facial expressions depending upon the situation during a continuing interaction or communication with a user. As opposed to previous development and inventions, such a MIP robot could exhibit all the multiple personality behaviors explicitly using more than one or multiple voice types and accompanying facial expressions, and capable of switching back and forth among multiple personalities during a continuing interaction or communication with a user, with a group of users, or with other robots. Such MIP type robots could be used as social robots including, but not limited to, situational comedy, karaoke, gaming, teaching and training, greeting, guiding and customer service types of applications with a touch of “human like” personality traits in addition to a typical “robot like” personality traits and limitations currently prevalent in this field.

According to one aspect of the present invention, the MIP robot's multiple interactive personalities could be exhibited by a computer synthesized voice representing typically a robot like personality traits, whereas a digitally recorded human voice representing a human like personality traits. The “human like” personality traits include, without any limitations, capability to ask questions, express emotions, tell jokes, make wise-cracking remarks, give philosophical answers on meaning of life and religion etc., like those of typical human users. The multiple interactive voices with suitable facial expressions in a robot interact or communicate with a user, a group of users, or other robots without any overlap or conflict between the different voices and the personalities represented therein. According to another aspect, suitable computer synthesized voices designed to match human voices or a specific human voice with suitable facial expressions could also be used to exhibit “human like” personality traits in such MIP robots.

According to another aspect, the suitable facial expressions accompanying multiple voices in a MIP robot are generated by including, but not limited to, suitable variation in the shape of eyes, eyelids, mouth, and lips. The input for determining a current situation is accessed by the MIP robot asking direct questions from the user based on the assessment and analysis of the input data of the previous situation. The MIP robot, without any limitations, may provide customized scripted response in a human like voice or personality to a user depending upon the situation, or may provide artificial intelligence (AI) based queried or analyzed robot like response in a robot like voice or personality depending upon the situation. The set of questions, and scripted responses to the typical user input data needed by a MIP robot may be stored, processed, and modified on-board within a robot, down loaded within a robot using web- or mobile interfaces, downloaded within a robot from a cloud based storage and computing system, or could be acquired from or interchanged with another robot during a continuing robot-user interaction or communication.

According to one aspect of the present invention, a purely software based animated version of a MIP robot is also created, which, without any limitations, is capable of interacting with a user via web- or mobile-interfaces. The software version of an animated MIP robot capable of text based chatting with multiple personality traits is called an animated MIP (AMIP) chat-bot. The software version of an animated MIP robot, capable of verbal or spoken communication with a user in multiple interactive voices with “human like” and “robot like” personalities is called an animated MIP (AMIP) chatter-bot.

In another aspect of the present invention, the AMIP chat- and chatter-bots are able to interact with a user in a human like personality traits in a “human like” manner, while also interact with a typical “robot like” personality traits in a robot like manner during a continuing interaction or conversation with the user through web- or mobile-interfaces. In another aspect, web- and mobile version of AMIP chat- and chatter-bots are capable of continuing interaction or communication with remotely located user or group of users to collect user specified input data including, but not limited to, user's questions, comments, scenarios, and feedback etc., on the robot responses within an internet based crowd sourcing environment.

In another aspect, the internet based crowd sourcing environment for a group of users may also give data on users including, but not limited to, user contact, gender, age-group, income group, education, geolocation, interests, likes, and dislikes etc., for remotely located users interacting with AMIP chat-bots and AMIP chatter-bots. The method also provides for acquiring sets of questions, addition and modifications to the questions, and responses to the questions from a web- or mobile-based crowd sourcing environment for creating default multiple personality types, and changes in the personality types for AMIP chat and chatter-bots as according to user preferences. In another aspect, the web- and mobile version of the AMIP chat- and chatter-bots also provide for the customization of the multiple interactive personalities as according to a user's preferences via a feedback loop. The customized personalities made using the AMIP chat- and chatter-bots as according to a user's preferences using the feed-back loop are then available for download into a MIP robot or robotic system for use during MIP robot-user interactions.

In one aspect, the method also provides for exemplary algorithms to go with above for a continuing interaction or communication of a MIP robot, or an AMIP chat- or chatter-bots with a user. The exemplary algorithms, without any limitation, include user-robot interactions with: (a) no over-lap or conflict in the responses and switching of multiple interactive personalities during a dialog, (b) customization of multiple interactive personalities according to a user's preferences using crowd sourcing environment, and (c) customization of the ratio of robot-like and human-like personality traits described above within MIP robots or within AMIP chat- or chatter bots as according to a user preferences.

The above summary is illustrative only and is not intended to be limiting in any way. The details of the one or more implementations of this invention disclosure are set forth in the accompanying drawings and detailed description below. Other features, objects, and advantages of the invention will be apparent from the description and drawings, and from the claims.

### BRIEF DESCRIPTION OF FIGURES

FIG. 1 An exemplary schematic of a MIP robot with main components.

FIGS. 2A-2B An exemplary schematic of a MIP robot interacting with a user, wherein the user is standing (FIG. 2A), and a user is sitting and another user is standing (FIG. 2B).

FIG. 3 Block diagrams and process flow of the main components of an exemplary algorithm of a MIP robot capable of speaking in multiple interactive voices with a user.

FIG. 4 Block diagram and process flow of an exemplary algorithm of an MIP robot dialog with a user in multiple interactive voices.

FIG. 5 Block diagram and process flow of an exemplary algorithm to incorporate a user feedback on a robot response in a MIP robot dialog with a user in multiple interactive voices.

FIGS. 6A-6B An exemplary schematic of an AMIP chat- or chatter bot interacting with a user through a web-interface (FIG. 6A) or mobile-interfaces (FIG. 6B).

FIGS. 7A-7B Block diagram and process flow for training the personalities of AMIP chat and chatter-bots according to user preferences using crowd sourcing of the feed-backs and alternative robot response transcripts submitted by the users.

FIG. 8 An exemplary video screen capture of an AMIP ran through a computer or mobile device.

FIGS. 9A-9B An exemplary algorithm for customizing the ratio of “human like” or “robot like” responses of MIP robots, or AMIP chat- and chatter-bots as according to user's preferences.

FIG. 10 An exemplary MIP robot with processing, storage, memory, sensor, controller, I/O, connectivity, and power units and ports within the robot system.

FIGS. 11A-11C Exemplary diagrams of animatronic head positions on robotic chassis for different movements.

FIGS. 12A-12B Exemplary diagrams of animatronic head rotations (FIG. 12A) and animatronic eyelid positions on the robotic chassis (FIG. 12B).

### DETAILED DESCRIPTION

The details of the present invention are described with illustrative examples to meet the statuary requirements for an invention disclosure. However, the description itself and the illustrative examples in figures are not intended to limit the scope of this invention disclosure. The inventors have contemplated that the subject matter of the present invention might also be embodied, in other ways, to include different steps or different combination of steps similar to the ones described in this document, in conjunction with the present and future technological advances. Similar symbols used in different illustrative figures identify similar components unless contextually stated otherwise. The terms herein, “steps,” “block,” and “flow” are used below, to explain different elements of the method employed, and should not be interpreted as implying any particular order among different steps unless any specific order is explicitly described for the embodiments of this invention.

Embodiments of the present invention are directed towards providing a method and system for a robot to generate and exhibit Multiple Interactive Personalities (MIP), with capability to switch back and forth among different personalities, during a continuing interaction or communication with a user depending upon the situation. Specifically, the MIPs in a robot are exhibited by the robot capable of speaking in more than one voice types, accents, and emotions accompanied with suitable facial expressions depending upon the situation during a continuing interaction or communication with a user. A synthesized digital voice may represent a robot like personality, whereas a digitally recorded human voice may represent a “human like personality” of the same robot. According to one aspect, with current future technological advances, suitable computer synthesized voices designed to match human voices or any specific human voice with suitable facial expressions, without any limitations, could also be used to exhibit “human like” personality traits in such MIP robots. As opposed to the previous development and inventions, such a MIP robot could exhibit all the multiple personality behaviors explicitly using multiple voice types and accompanying facial expressions and switch back and forth during a continuing interaction or communication with a user, a group of users or even with other robots.

Based on the embodiments of the present invention, a MIP robot is able to express emotions, ask direct questions, tell jokes, make wise-cracking remarks, give applause, and give philosophical answers in a “human like” manner with a “human like” voice during a continuing interaction or communication with a user, while also interacting and speaking in a “robot like” manner and “robot like” voice during the same continuing interaction or communication with the same user without any overlap or conflict. Such MIP robots can be used as entertaining social robots including, but not limited to, situational or stand-up comedy, karaoke, gaming, teaching and training, greeting, guiding and customer service types of applications.

According to another embodiment, the input for determining the situation is accessed by a MIP robot asking direct questions to a user as “humans normally do” in addition to accessing and analyzing the input data obtained from various onboard sensors for user, context of user, and the situation with in an interaction environment at that time. The MIP robot may provide custom response to a user based upon the personality type suitable for the situation at the moment. The set of questions and scripted responses, needed by multiple personalities of a MIP robot to assess the situation and determine a user's mood depending upon the situation, may be stored, processed, and modified on-board within a robot during a continuing interaction or communication with a user, down loaded within a MIP robot using web- or mobile based interfaces, down-loaded from a cloud computing based system, or can be acquired or interchanged from another robot.

According to another embodiment, software based animated version of MIP robot is also created, which, without any limitations, is capable of interacting with a user via a web- or mobile-interfaces supported on personal computers, tablets, and smart phones. An animated version of a MIP robot, capable of chatting with a user using a web- or mobile-interfaces in “human like” and “robot like” personalities during a continuing interaction or communication with a user and capable of switching is called an animated MIP (AMIP) chat-bot. An animated version of a MIP robot, capable of verbally talking or speaking with a user in multiple voices in “human and robot like” interactive personalities and capable of switching during a continuing interaction or communication with a user is called an animated MIP (AMIP) chatter-bot. The AMIP chat- and chatter-bots are able to assess and respond to a user's mood and situation by asking direct questions, express emotions, tell jokes, make wise-cracking remarks, give applause, and give philosophical answers in a human like manner during a continuing interaction or communication with a user, while also assessing and responding in a robot like personality during the same continuing interaction or communication with the same user.

According to another embodiment, the AMIP chat- and chatter-bots capable of interacting with a remotely situated user or a group of users using web- or mobile-interfaces are used to collect user specified chat- and chatter-input data including, but not limited to, user's questions, comments, and input on comedic- and gaming-scenarios, karaoke song requests, and other suggestions within an internet based crowd sourcing environment. The internet based crowd sourcing environment for a group of users may also include collecting user input data including, but not limited to, user contact, geolocation, interests, and user's likes and dislikes etc., about the interaction environment, responses of multiple interacting personalities, and the situation at the moment.

In another embodiment, users' input data is used in a moderated feed-back loop to train and customize the multiple interactive personalities of AMIP chat- and chatter-bots to suit users' own preferences. The user preferred customized personalities of AMIP chat- and chatter-bots are then downloaded for use in remotely connected MIP robots using web- and mobile interfaces, cloud computing environments, and a multitude of hardware input devices ports including, but not limited to, USB, HDMI, touch screen, mouse, key-board, and a SIM card for mobile wireless data connection. In another embodiment, a crowd sourced group of users is allowed to train multiple personalities of AMIP chat- and chatter-bots and MIP robot for general uses, and a user is also allowed to train and customize multiple personalities of an AMIP chat- or chatter-bot and a MIP robot according to user's own preferences. The moderated feed-back loop in a crowd sourcing embodiment is used to prevent and limit a user or group of users from creating undesired or abusive multiple interactive personalities including, but not limited to, national, racial, sexual orientation, color, and religious origin related references and discrimination using AMIP chat- and chatter-bots, and MIP robots.

In another embodiment, the user preferred and customized AMIP chat and chatter-bots using web- and mobile interfaces and MIP robots at a physical location are used for applications including, but not limited to, educational training and teaching, child care, gaming, situational and standup comedy, karaoke singing, and other entertainment routines while still providing all the useful functionalities of a typical robot or a social robot.

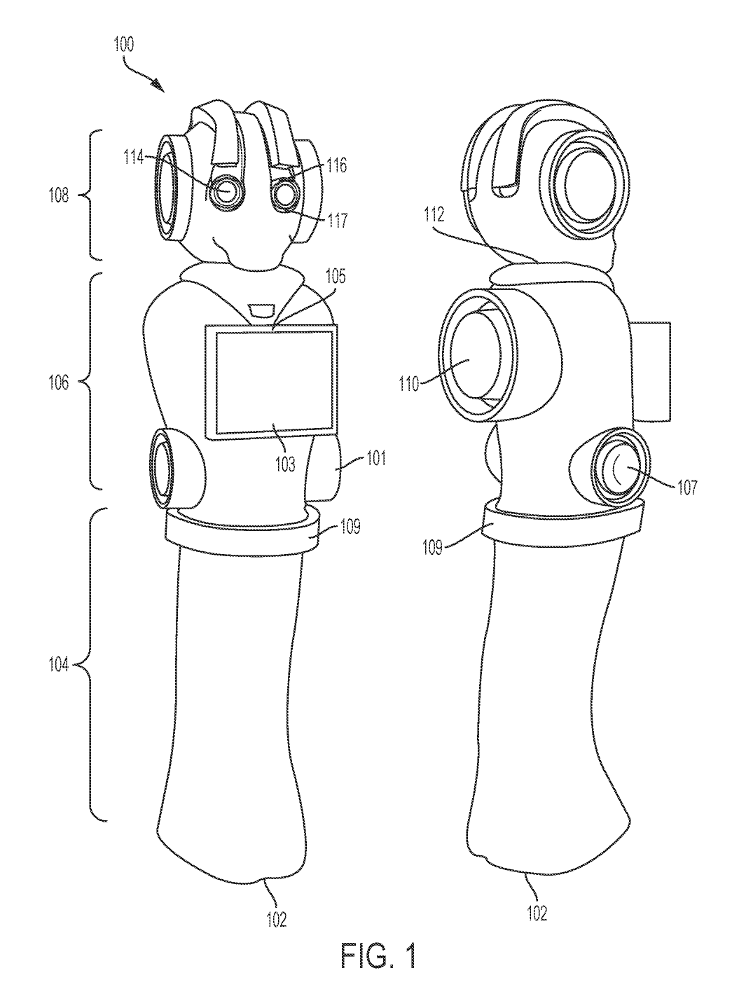

Having briefly described an exemplary overview of the embodiments of the present invention, an exemplary MIP robot system, and components in which embodiments of the present invention may be implemented are described below in order to provide a general context of various aspects of the present invention. Referring now to FIG. 1, an exemplary MIP robot system for implementing embodiments of the present invention is shown and designated generally as a MIP robot device 100. It should be understood that the MIP robot device 100 and other arrangements described herein are set forth only as examples and are not intended to be of suggest any limitation as to the scope of the use and functionality of the present invention. Other arrangements and elements (e.g. machines, interfaces, functions, orders, and groupings etc.) can be used instead of the ones shown, and some elements may be omitted altogether and some new elements may be added depending upon the current and future status of relevant technologies without altering the embodiments of the present invention. Furthermore, the blocks, steps, processes, devices, and entities described in this disclosure may be implemented as discrete or distributed components or in conjunction with other components, and in any suitable combination and location. Various functions described herein as being performed by the blocks shown in figures may be carried out by hardware, firmware, and/or software.

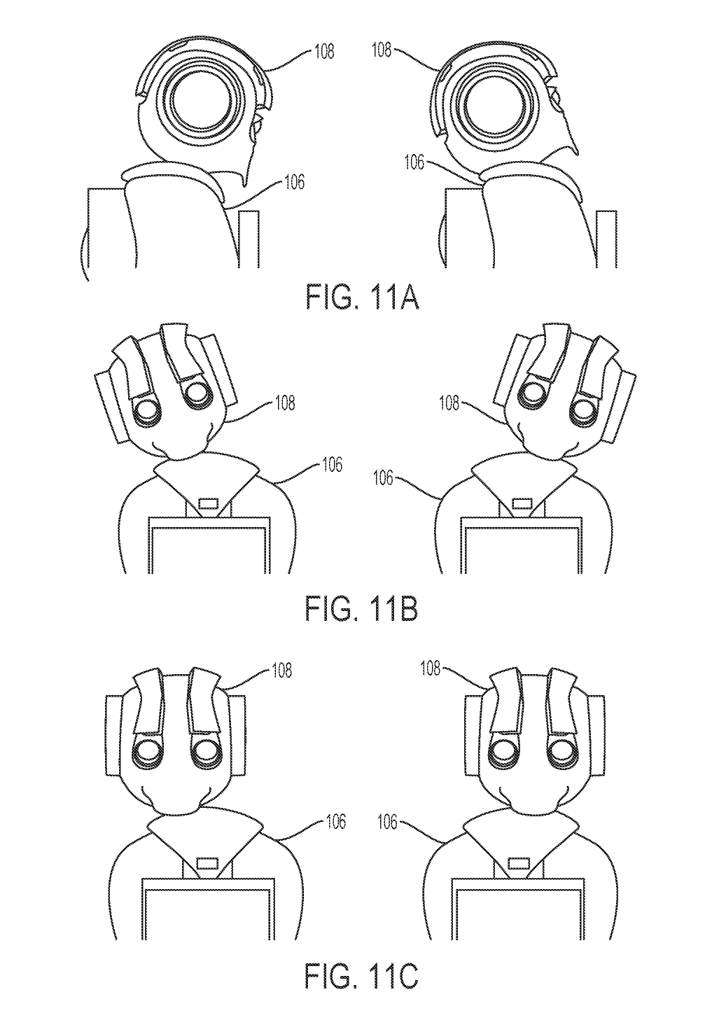

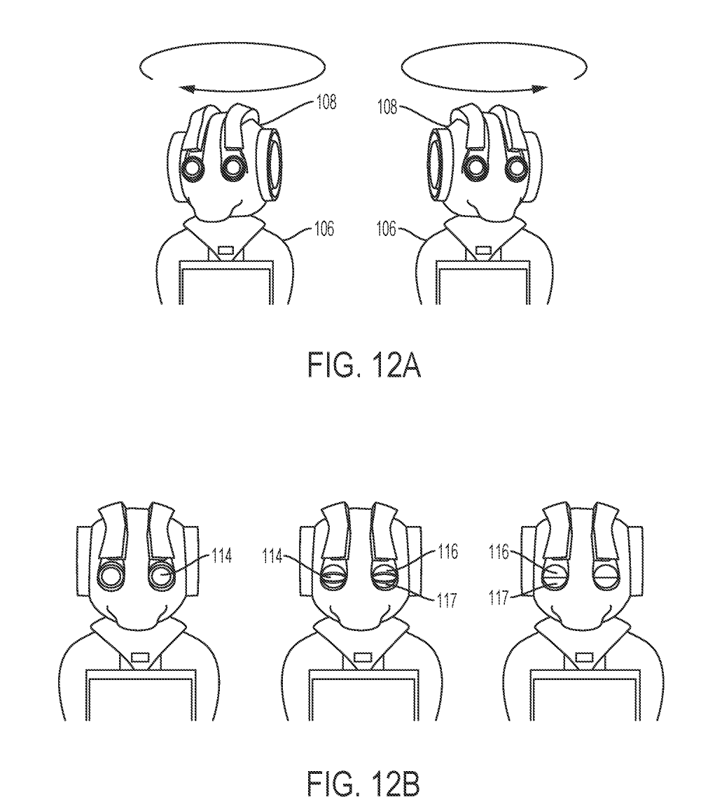

A MIP robotic device 100 in FIG. 1 includes, without any limitation, a base 104, a torso 106, and a head 108. The base 104 supports the robot and includes wheels (not shown) for mobility which are inside of base 104. The base 104 includes internal power supplies, charging mechanisms, and batteries. In one embodiment, the base 104 could itself be supported on another moving platform 102 with wheels for the MIP robot to move around in an environment including a user or a group user configured to interact with the MIP robot. The torso 106 includes a video camera 105, touch screen display 103, left 101 and right 107 speakers, a sub-woofer speaker 110 and I/O ports for connecting external devices 109 (exemplary location shown). In one embodiment, the display 103 is used to show the text form display of the “human like” voice to represent “human like” trait or personality spoken through speakers and a sound-wave form display of the synthesized robotic voice spoken through speakers to represent “robot like” personality of the MIP robot. The head 108 includes a neck 112 with 6 degrees of movement, up, down, pitch, roll, yaw, left, right forward and backward movements (see FIGS. 11A-C and 12A). The changing facial expressions are accomplished with eyes lit with RGB LED's 114, with opening and closing animatronic upper eyelids 116 and lower eyelids 117 (see FIG. 12B for eyelid configurations). In addition to the above list of general components and their functions, a typical robot also includes power unit, charging, computing or processing unit, storage unit, memory unit, connectivity devices and ports, and a variety of sensors and controllers. These structural and component building blocks of a MIP robot represent exemplary logical, processing, sensor, display, detection, control, storage, memory, power, input/output and not necessarily actual, components of a MIP robot. For example a display device unit could touch or touch less with or without mouse and keyboard, with USB, HDMI, and Ethernet cable ports could be representing the key I/O components, a processor unit could also have memory and storage as according to the art of technology. FIG. 1 is an illustrative example of a MIP robot device that can be used with one or more embodiments of the present invention.

The invention may be described in the general context of a robot with onboard sensors, speakers, computer, power unit, display, and a variety of I/O ports. Wherein the computer or computing unit includes, without any limitation, the computer codes or machine readable instructions, including computer readable program modules executable by a computer to process and interpret input data generated from a MIP robot configured to interact with a user or a group of user and generate output response through multiple interactive voices representing switchable multiple interactive personalities (MIP) including human like and robot like personality traits. Generally, program modules include routines, programs, objects, components, data structures etc., referring to computer codes that take input data, perform particular tasks, and produce appropriate response by the robot. Through the USB, Ethernet, WIFI, modem, HDMI ports the MIP robot is also connected to the internet and cloud computing environment capable of uploading and downloading of the personalities, questions, user response feed backs, and modified personalities from and to the remote source such as cloud computing and storage environment, a user or group of users configured to interact with the MIP robot in person, and other robots within the interaction environments.

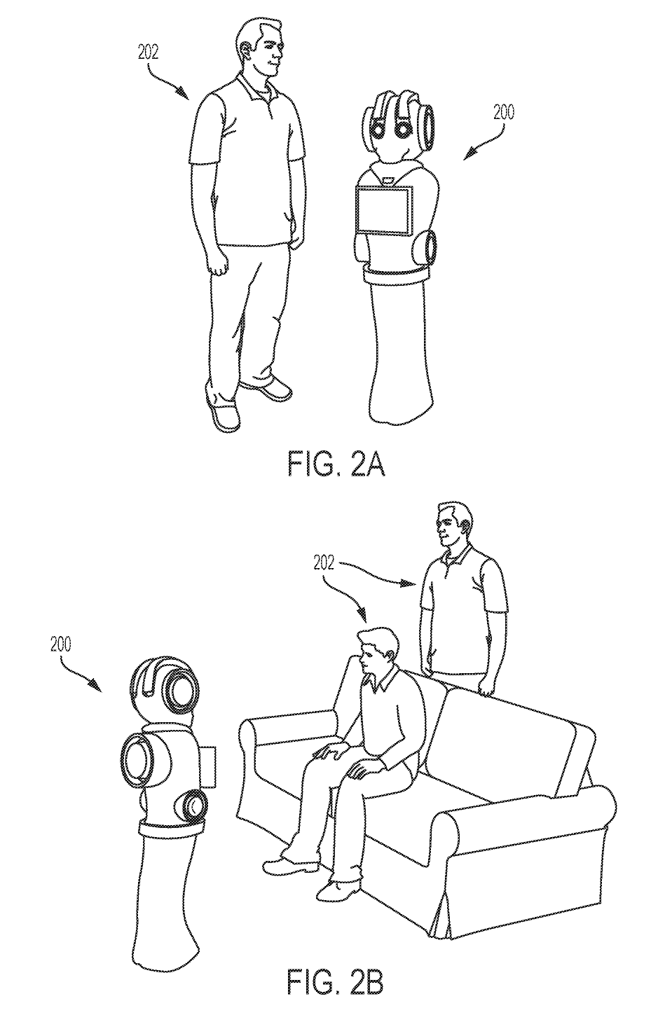

FIGS. 2A and 2B, without any limitation, are exemplary environments of a MIP robot configured interact with a user 202, wherein the user 202 is standing (FIG. 2A) and wherein MIP robot is situated in front of a user or other group of users 202 sitting (e.g., on a couch) and/or standing in the same or similar environments (FIG. 2B). The exemplary MIP robot device 200 is same that is detailed in MIP robot device 100 of FIG. 1. The robot device 200 can take input data from the user 202 using on-board sensors, camera, microphones in conjunction with facial and speech recognition algorithms processed by the onboard computer, direct input from the user including, but not limited to, the exemplary touch screen display, key-board, mouse, game controller etc. The user or group of users 202 are configured to interact with the MIP robot 200 within this exemplary environment and can communicate with the MIP robot 200 using talking, typing of text on a keyboard, sending game controlling signals via the game controller, and expressing emotions including, but not limited to, direct talking, crying, laughing, singing and making jokes. In response to the input data received by the MIP robot, the robot may choose to respond with a human like personality in a human like voices and recorded scenarios or a robot like personality in robot like voices and responses.

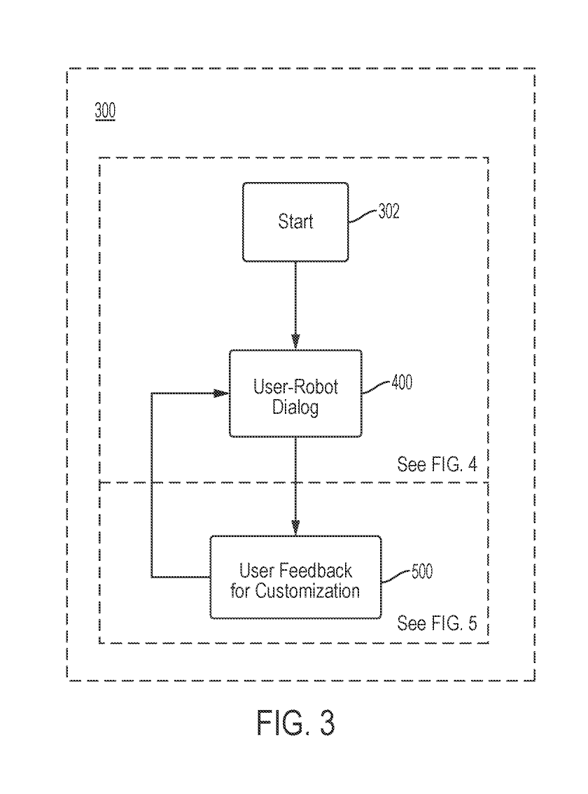

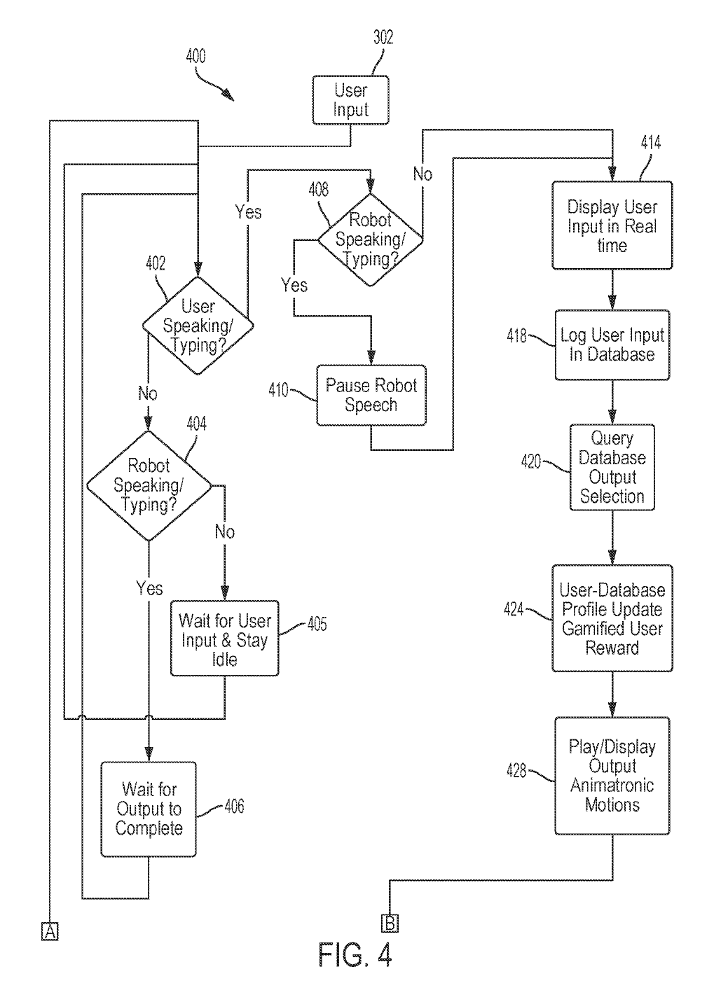

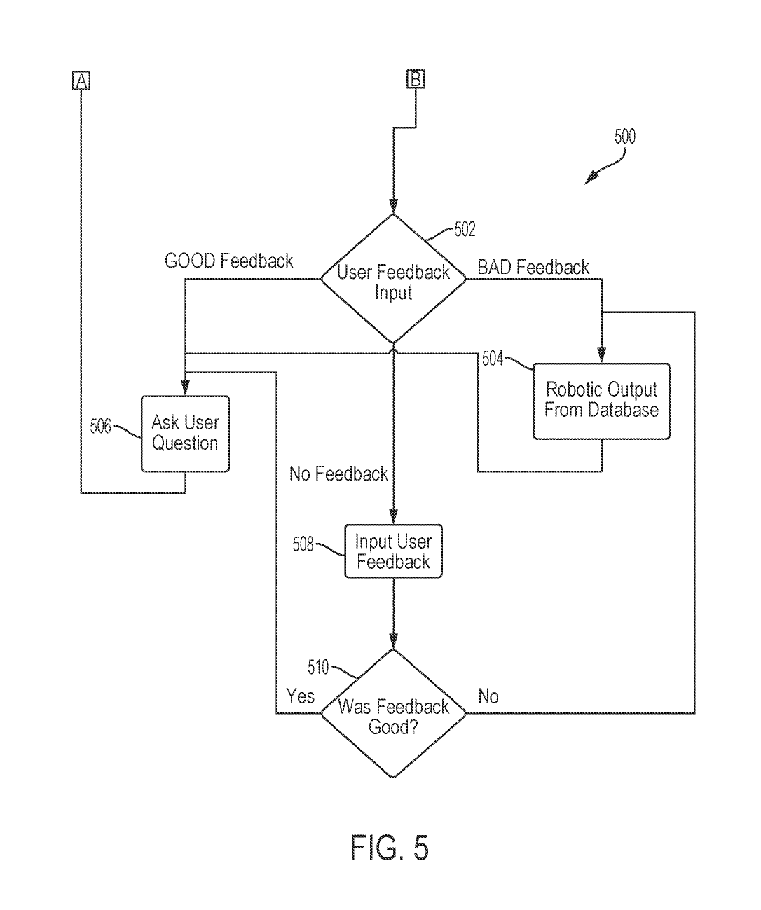

An exemplary algorithm and process flow diagram of an interaction of an MIP robot capable of speaking with a user in a robot like voice or a human like voice, and switching between the personalities without any overlap or conflict between the personalities is described in FIGS. 3-5. The overall system flow chart 300 to accomplish this in FIG. 3, shows that there are two main steps in the process flow. The step 1 for user-robot dialog 400, takes the input 302 from a user based on a previous interaction or communication, decides if the robot will speak or the user will be allowed to continue. If it is the turn of the robot to speak, then based on the input data, the MIP robot analyzes the situation and decides if the robot will speak in a robot like personality or in a human like personality. The step 2 for user feedback for customization 500, takes the user feedback and gives a suitable response. As illustrated in FIG. 3, the steps 400 and 500 are described further in FIGS. 4 and 5, respectively.

An exemplary algorithm and process flow for taking the input from a user based on a previous interaction or communication, with robot deciding if the user or the robot with robot or human like personalities will respond is shown. The input from a previous interaction or communication is received in 302. An analysis of the input 302 is done in 402 to decide if the user is speaking or typing an input. If the user is not speaking or typing an input, the step 404 checks if the robot is speaking or typing. If the robot is speaking or typing, step 406 lets the currently active audio and text output complete and waits for further user input when done. If the robot is not speaking or typing in step 405 the robot will wait or idle for further input or interaction. If on the other hand in the analysis and decision box 402 a user is speaking or typing, the box 408 checks if the robot is speaking or typing. If the robot is speaking in box 408, box 410 pauses robot's speech and the voice input from the user is translated into text and typed in the display screen of the robot in the box 414 to make it easier for a user to verify what the robot is hearing from the user. The user, therefore, can see their voice displayed as text on robot's display screen and the displayed text is also recorded through 418 in user log database. After a user's voice or text input is recorded in the database in 418, the database is queried in box 420, user profile is updated in box 424, and the query is analyzed for a decision and acted upon for a response in box 428. If there is a pre-recorded response in box 428 to the user's current input or query in 418, the pre-recorded response is played on the output and accompanied with robot's facial expression changes and other movements in box 428. If there is no pre-recorded response to the user's current input in decision box 418, the user database is updated in box 424 and user is rewarded with a pre-recorded gameified response awarding user with digital rewards such as score, badge, coupons, certificates etc. to incentivize user interaction and retain and engage user. After a user is rewarded in box 424, a typical robot response in a robot like voice or robot chat response is given to the user. This is the third potential outcome to the output 428 of the user-robot dialog interaction algorithm detailed in 400 and shown in FIG. 4.

The process flow of the user-dialog algorithm described above, without any limitations, ensures that to the user's current input in box 302, the output 428 is that: either robot speaks/types a pre-recorded response, i.e., the robot plays a pre-recorded “human like” response from the database accompanied with suitable facial expression changes and other movements, or the robot responds in a synthesized chatter voice in a robot like response from box 420. The box 418 logs-in user's voice or text input for future analysis and further gradual machine learning and artificial intelligence driven improvements. If there is no suitable response found, box 424 rewards a user with a gameified response and awards points, coupons, badges, and certificates etc., to encourage user to give feed-back, inputs, scripted scenarios for further improvements in the MIP and AMIP types of robots and chatter-bots, respectively. The feed-back given by a user on the output response 428 is described in the feedback algorithm described in FIG. 5.

The process flow for user feedback 500 is shown in FIG. 5. The output response 428 by the robot is received by the user, and the user is prompted for a feedback in the form of simple thumbs up or down, voice, keyboard, or mouse click type responses in box 502. If the feedback is bad, user is played a robotic pre-recorded message in box 504. If the feedback is good, the user is asked another question as an input in box 506 to continue the process again to the user next input step 402. If the there is no feedback by a user, another pre-recorded robotic response is given in box 508 asking again for a user feedback. If the resulting feedback is bad user is given the pre-recorded answer of box 504, however if the feedback is good user is directed to box 506 to ask a pre-recorded question to continue the process at the next user input step 402.

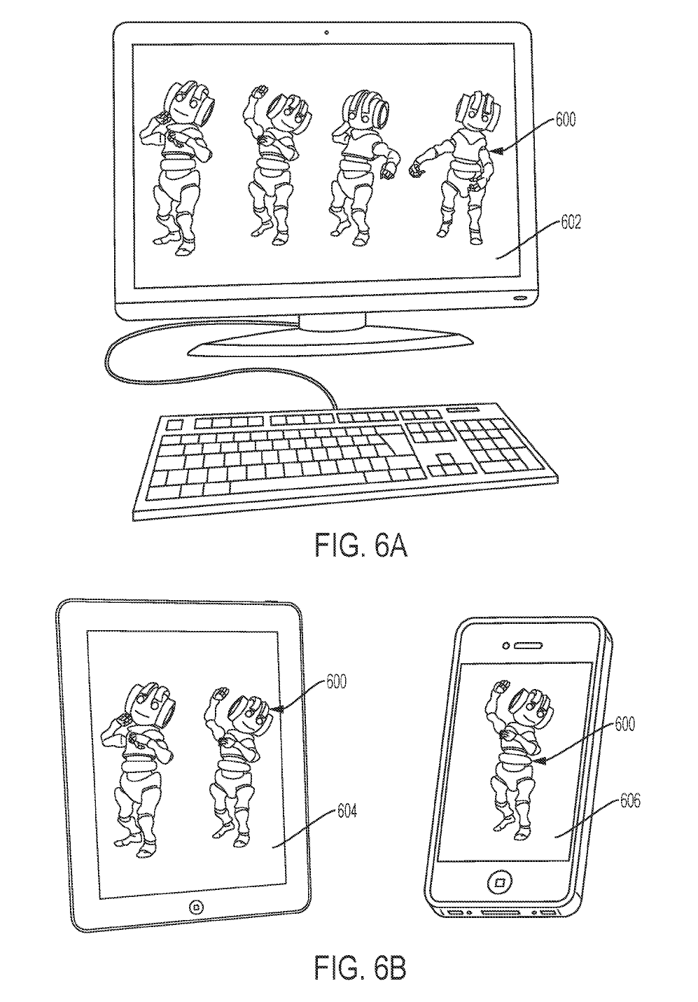

According to an embodiment, a purely software based animated version of a MIP robot is also created, which, without any limitations, is capable of interacting with a user via a web- or mobile-interface on internet connected web- or mobile devices, respectively. An animated version of a MIP robot 600, capable of chatting with a user using a web- or mobile-interface is called an animated MIP (AMIP) chat-bot. An animated version of a MIP robot 600, capable of speaking with a user in multiple voices in human and robot like personalities is called an animated MIP (AMIP) chatter-bot. An exemplary sketch of an AMIP chat- or chatter bot 600 on a web interface 602 is shown in FIG. 6A, where as an exemplary sketch of an AMIP chat- or chatter-bot 600 on mobile tablet interface 604 or smart-phone interface 606 is shown in FIG. 6B. The AMIP chat- and chatter-bots are able to assess a user's mood and situation by asking direct questions, express emotions, tell jokes, make wise-cracking remarks, give applause, and give philosophical answers in a human like manner during a continuing interaction or communication with a user, while also responding in a robot like manner during the same continuing interaction or communication with the same user.

According to another embodiment, the AMIP chat- and chatter-bots interacting with a remotely connected user or a group of users using web- or mobile-interfaces are used to collect user specified chat- and chatter input data including, but not limited to, user contact, gender, age-group, income group, education, geolocation, interests, likes and dislikes, as well as user's questions, comments, scripted scenarios and feed-back etc., on the AMIP chat- and chatter-bot responses within a web- and mobile-based crowd sourcing environment.

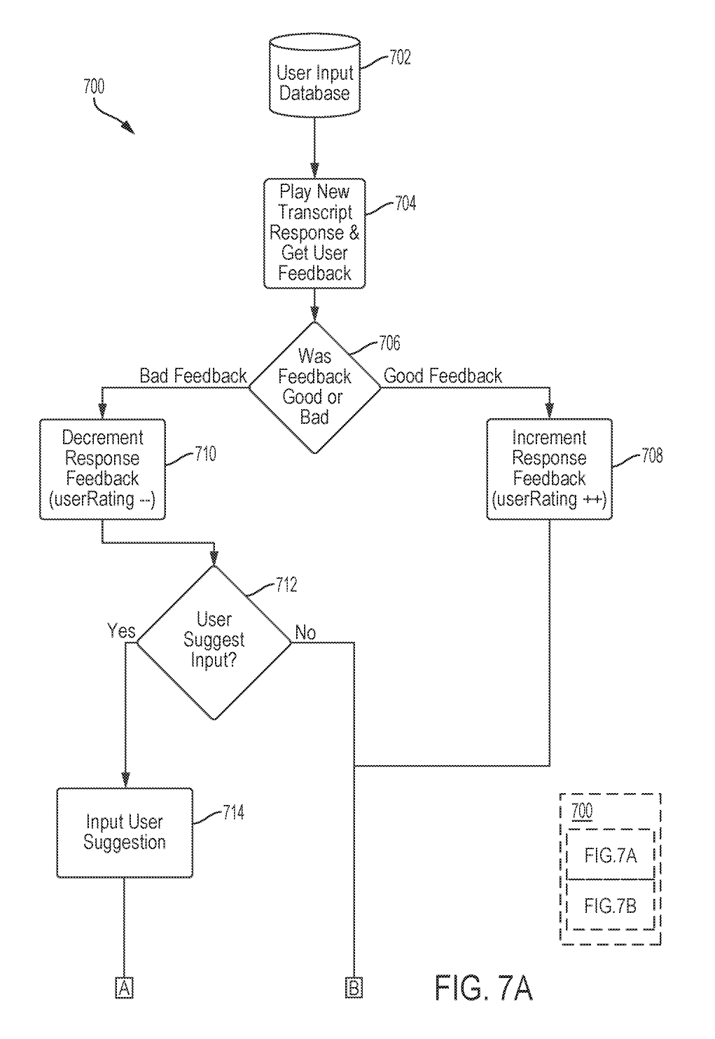

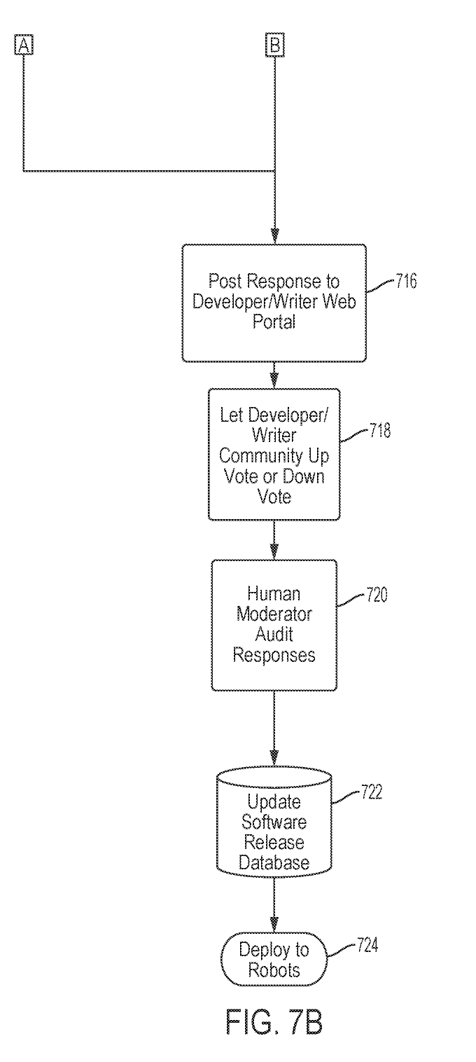

According to an embodiment, an exemplary algorithm and process flow, without any limitation, for a dialog of an AMIP chat- or chatter-bot with a user or a group of users for crowd sourcing of the training input-data, and getting the users' feed-back on the response of the AMIP chat- or chatter-bots is described in 700 in FIG. 7A and continued in FIG. 7B. The process flow begins with the current database of previous robot chat- and chatter responses and user input 702. A new transcript of the recorded robot response is played for a user and a user's feedback is obtained in box 704. If a user gives a bad or negative feedback in box 706, the response feedback on the new transcript within the database is given a decrement or negative rating in box 710. If a user gives a good or positive feedback in box 706, the response feedback on the new transcript within the database is given an increment or positive rating in box 708. For a user's bad or negative feedback in box 710, a user is asked in box 712 if the user would like to submit an alternative response. If a user's answer is yes, the user is asked to submit an alternative response 714 and the user is directed to for posting the alternative response to the development writer's portal in box 716. If a user's answer is no, the user is still directed to the development writer's portal in box 716 as a next step. For a user's good feedback and the increment rating on the new transcript in box 708, the new transcript is posted to the development writer's portal in box 716 as a next step. In box 718, the development writer's community up-votes or down-votes on the posted new transcript from box 708 or the alternative response transcript submitted by a user from box 714. The moderator accepts or rejects the new transcripts or alternative response transcript in box 720. The software response database is updated in box 722, and the updated response database is ready to download to an improved MIP robot or an AMIP chat- or chatter-bot in box 724.

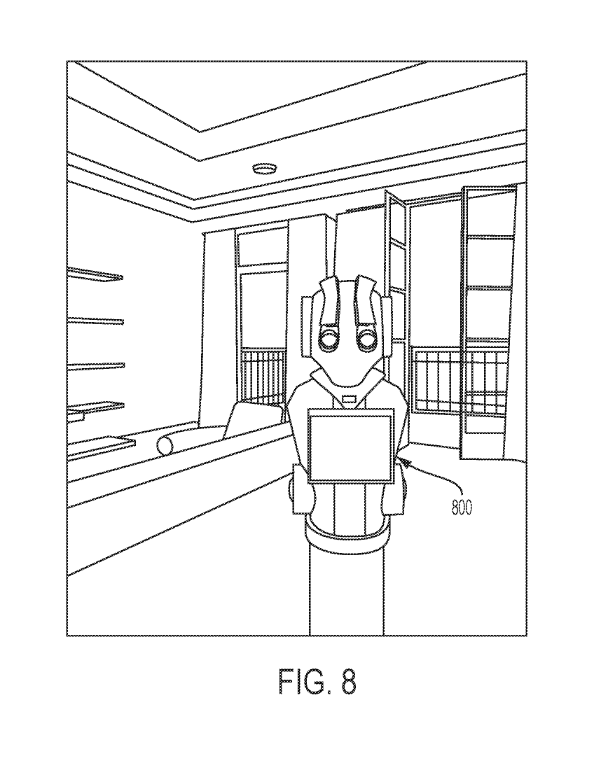

As an embodiment of this invention, an exemplary working version of AMIP chatter-bot 800, displayed on the screen of a web-interface on a desktop computer screen is shown in FIG. 8. This AMIP chatter-bot 800 was used and tested for communicating and interacting with a human user in both “robot like” and “human like” personalities traits with no overlapping or conflict between the two, and with on-demand switching between the “human like” and “robot like” voices, facial expressions and personalities. As an another embodiment of this invention, the AMIP chatter-bot 800 of FIG. 8 was also used to get a user feed-back, ratings, and alternative scripted scenarios in a simulation of crowd sourcing method described above in FIGS. 7A and 7B.

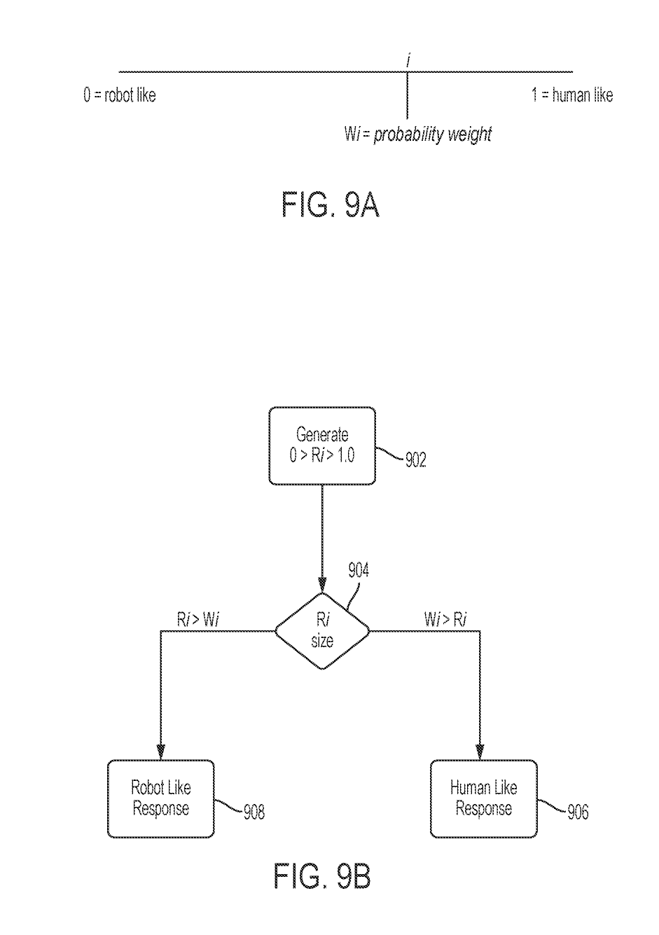

According to an embodiment, the ratio of “human like” to “robot like” personality traits within a MIP robot or AMIP chat- or chatter-bots can be varied and customized as according to a user's or a user groups' preferences. This is done by including an additional probabilistic or stochastic component during a user-robot dialog algorithm described in FIGS. 4-5. An exemplary algorithm to accomplish this, without any limitation, is described in FIGS. 9A-9B. If there is a pre-recorded “human like” robot response to a user input in box 428, a probabilistic weight Wi for a user i with 0<Wi<1 is used to choose if the robot will respond with a “human like” personality trait or a “robot like” personality trait (FIG. 9A). In FIG. 9B, a random number 0<Ri<1 is generated in box 902 and compared with Wi in box 904. For Wi>Ri, MIP robot or AMIP chat- or chatter-bots respond with “human like personality” traits in box 906, otherwise the MIP robot or AMIP chat- or chatter bots respond with a “robot like” personality traits in box 908. The probabilistic weight factors Wi for a user or Wg for a group of users may be generated by an exemplary steady state Monte Carlo type Algorithm during the training of the robot using crowd-sourcing user input and feedback approach described in FIGS. 7A-7B.

According to another embodiment, the probabilistic weight factors Wi for a user or Wg for a group of users are correlated with user preferences for jovial, romantic, business type, fact based, philosophical, teacher type responses by an MIP robot or AMIP chat- or chatter-bots. Once enough “human like” responses are populated within the robot response database, some users may prefer jovial responses, while some other users may prefer romantic responses, while some other users may prefer business like or fact based responses, while still some other users may prefer philosophical, teacher type, or soulful responses. For example, the probability weight factors Wi closer to 1 may prefer mostly “human like” responses, wherein the probability weight factors Wi closer to 0 may prefer mostly “robot like” responses (FIG. 9A). Exemplary clustering and correlation type plots may segregate a group of users into sub-groups preferring jovial or comedic, emotional or romantic, business or fact based, philosophical, inspirational, religious or teacher type responses without any limitations.

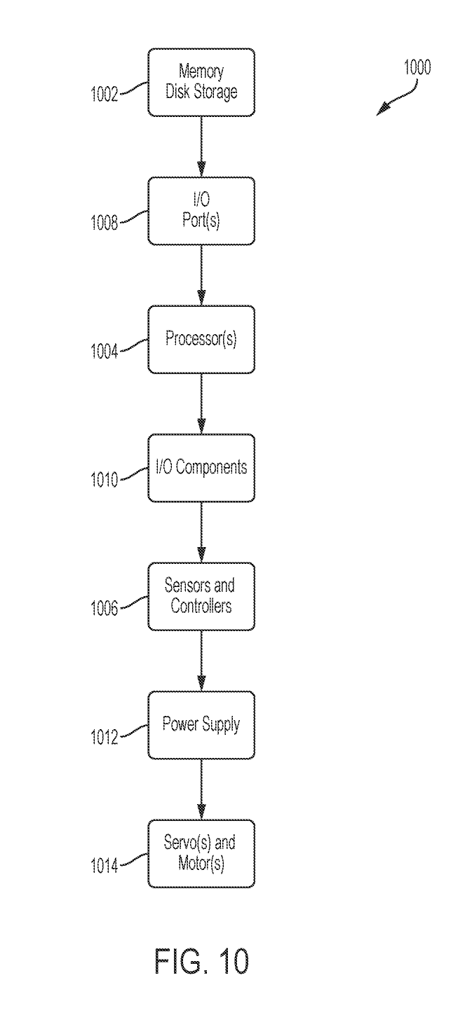

Having briefly described an exemplary overview of the embodiments of the present invention, exemplary operating environment, system, and components in which embodiments of a MIP robot may be implemented are described below in order to provide a general robot context of various aspects of the present invention. It should be understood that the robot operating environment and the components in 1000 and other arrangements described herein are set forth only as examples and are not intended to be of suggest any limitation as to the scope of the use and functionality of the present invention. The robotic device 1000 in FIG. 10 includes one or more than one buses that directly or indirectly couples memory/storage 1002, one or more processors 1004, sensors and controllers 1006, input/output ports 1008, input output components 1010, and an illustrative power supply 1012, and servos and motors in 1014. These blocks represent logical, not necessarily actual, components. For example a display device could be an I/O components, processor could also have memory as according to the nature of art. FIG. 10 is an illustrative example of environment, computing, processing, storage, display, sensor, and controller devices that can be used with one or more embodiments of the present invention.

Lastly, as an embodiment of the present invention, in FIGS. 11A-11C and 12A-12B we show the six degree motions of head and accompanying eye and eye lid changes to generate suitable facial expressions to go with multiple interactive voices and personalities described in this invention. FIGS. 11A-11C and 12A show exemplary six degrees of motion of the head 108 in relation to the torso 106. In various aspects, the six degrees of motion include pitch (FIG. 11A, rotate/look down and rotate/look up), yaw (FIG. 12A, rotate/look right and rotate/look left), and roll (FIG. 11B, rotate right and rotate left in the direction of view). In one alternative aspect, the degrees of motion include translations of the head 108 in relation to the torso 106 (FIG. 11C, translation/shift right and translation/shift left in the direction of view. In yet another alternative aspect, the degrees of motion include further translations of the head 108 in relation to the torso 106 (not shown, translation/shift forward and translation/shift backward in the direction of view). FIG. 12B shows motions of the eyelids 116 and/or 117 (e.g., fully open, partially closed, closed) and of eyes possible using LED lights 114 in the background.

The components and tools used in the preset invention may be implemented on one or more computers executing software instructions. According to one embodiment of the present invention, the tools used may communicate with server and client computer systems that transmit and receive data over a computer network or a fiber or copper-based telecommunications network. The steps of accessing, downloading, and manipulating the data, as well as other aspects of the present invention are implemented by central processing units (CPU) in the server and client computers executing sequences of instructions stored in a memory. The memory may be a random access memory (RAM), read-only memory (ROM), a persistent store, such as a mass storage device, or any combination of these devices. Execution of the sequences of instructions causes the CPU to perform steps according to embodiments of the present invention.

The instructions may be loaded into the memory of the server or client computers from a storage device or from one or more other computer systems over a network connection. For example, a client computer may transmit a sequence of instructions to the server computer in response to a message transmitted to the client over a network by the server. As the server receives the instructions over the network connection, it stores the instructions in memory. The server may store the instructions for later execution, or it may execute the instructions as they arrive over the network connection. In some cases, the CPU may directly support the downloaded instructions. In other cases, the instructions may not be directly executable by the CPU, and may instead be executed by an interpreter that interprets the instructions. In other embodiments, hardwired circuitry may be used in place of, or in combination with, software instructions to implement the present invention. Thus tools used in the present invention are not limited to any specific combination of hardware circuitry and software, nor to any particular source for the instructions executed by the server or client computers. In some instances, the client and server functionality may be implemented on a single computer platform.

Thus, the present invention is not limited to the embodiments described herein and the constituent elements of the invention can be modified in various manners without departing from the spirit and scope of the invention. Various aspects of the invention can also be extracted from any appropriate combination of a plurality of constituent elements disclosed in the embodiments. Some constituent elements may be deleted in all of the constituent elements disclosed in the embodiments. The constituent elements described in different embodiments may be combined arbitrarily.

The embodiments of the present invention are described more fully hereinafter with reference to the accompanying drawings, which form a part hereof, and which show, by way of illustration, specific exemplary embodiments by which the invention may be practiced. This invention may, however, be embodied in many different forms and should not be construed as limited to the embodiments set forth herein. Rather, the disclosed embodiments are provided so that this disclosure will be thorough and complete, and will fully convey the scope of the invention to those skilled in the art.

Throughout the specification and claims, the following terms take the meanings explicitly associated herein, unless the context clearly dictates otherwise. The phrase “in one embodiment” as used herein does not necessarily refer to the same embodiment, though it may. Furthermore, the phrase “in another embodiment” as used herein does not necessarily refer to a different embodiment, although it may. Thus, as described below, various embodiments of the invention may be readily combined, without departing from the scope or spirit of the invention.

Various embodiments are described in the following numbered clauses:

1. A method for providing one or more than one personality types to a robot, wherein the method comprises of:

providing a robot with a capability to speak in one or more than one voice type, accent, languages, and emotions accompanied with suitable facial expressions to exhibit one or more than one interactive personality types capable of switching back and forth among different personalities during a continuing interaction or communication with a user or a group of users;

providing a robot, with a capability to ask direct questions and obtain additional information using, but not limited to, sound, speech, and facial recognition sensors on the robot and using a connection device, wherein the information relates to the interaction or communication between a user or a group of users and the robotic device interacting with each other;

providing the robot, with a capability to processes the information to generate data to enable the robot to respond and speak in any one or more than one voice types with chosen accent, language and emotion with accompanying facial expressions so as to give the robot multiple interactive personalities with ability to switch between the personalities during a continuing interaction or communication with a user, wherein the processing of the obtained information occurs onboard within the robotic device for a faster speed and instantaneous response by the robot to a user without any overlap or conflict between multiple personalities or voices of the robot; and

providing the robot, with a capability to exhibit one or more than one interactive personality types and switch between them during a continuing interaction or communication between the robot and a user or a group of users.

2. The method of clause 1, wherein the robot includes the ability to speak in a default synthesized or computer generated synthetic voice to represent a default robot like personality.
3. The method of clause 1, wherein the robot also includes a capability to speak in one or more than one digitally recorded human voices to represent “human like” multiple personalities during a continuing interaction of the robot with a user or group of users.
4. The method of clause 3, wherein one or more than one “human like” personalities speaking in digitally recorded human voices or in synthesized “human like voices” ask questions and express emotions during interactions with a user or a group of users, while the default robot like personality of clause 2 speaks in a synthesized robot like voice during the same continuing interaction or communication with a user or a group of users.
5. The method of clause 4, wherein the robot like personality speaking in a synthesized robot like voice can respond with artificial intelligence (AI) learned and analyzed facts and figures and without exhibiting any emotions or asking any question during the same continuing interaction or communication with a user or a group of users.
6. The method of clause 4, wherein one or more than one “human like” personalities can also speak in computer synthesized voices engineered voices to mimic human like voices of specific persons or personalities with capability to ask questions and expression emotions during a continuing interaction or communication with a user or group of users.
7. The method of clause 1, wherein the languages, without any limitation, include any one or combination of the major spoken languages including English, French, Spanish, German, Portuguese, Chinese-Mandarin, Chinese-Cantonese, Korean, Japanese and major South Asian and Indian languages such as Hindi, Urdu, Punjabi, Bengali, Gujrati, Marathi, Tamil, Telugu, Malayalam, and Konkani.
8. The method of clause 1, wherein the allowed accents, without any limitation, include localized speaking style or dialect of any one or combination of the major spoken languages of clause 7.
9. The method of clause 1, wherein the emotions of the spoken words or speech, without any limitation may include variations in tone, pitch, and volume to represent emotions commonly associated with digitally recorded human voices.
10. The method of clause 1, wherein the suitable facial expressions to accompany a voice or personality type in the robot are generated by variation in the shape of eyes, color changes in eyes using miniature LED lights, and shape of the eyelids as well the six degrees of motion of head in relation to the torso.
11. The method of clause 1, wherein the suitable facial expressions to accompany a voice or personality type in the robotic device are generated by variation in the shape of the mouth and lips using miniature LED lights.
12. The method of clause 1, wherein a voice or personality type with suitable facial expressions in the robotic device, without any limitation, are accompanied with hand movements or gestures of the robot.
13. The method of clause 1, wherein multiple personality types with suitable facial expressions in a robot are accompanied with a motion of the robot within an interaction range or communication range, without any limitation, of a user or a group of users configured to interact with each other and with the robot.
14. The method of clause 1, wherein the robot is capable of computing on-board and is configured to interact with an ambient environment without a user or group of users present within the environment.
15. The method of clause 1, wherein the robot is configured to interact with another robot of the method of clause 1 within an ambient environment without any user or a group of users present within the environment.
16. The method of clause 1, wherein the robot is configured to interact with another robot of the method of clause 1 within an ambient environment with a user or a group of users present in the environment.
17. The method of clause 1, wherein the connection device may include, without any limitation, a key-board, a touch screen, an HDMI cable, a personal computer, a mobile smart phone, a tablet computer, a telephone line, a wireless mobile, an Ethernet cable, or a Wi-Fi connection.
18. The method of clause 1, wherein the human like personalities of clauses 4 and 6 of the robot, without any limitation, may be based on the context of the local geographical location, local weather, local time of the day, and the recorded historical information of a user or group of user configured to interact with a robotic device.
19. The method of clause 1, wherein the human like personalities of clauses 4 and 6 of the robot, without any limitation, may tell jokes, express happy and sad emotions, sing songs, play music, make encouraging remarks, make inspirational remarks, make wise-cracking remarks, perform a recorded comedy routine etc., for the entertainment of a user or a group of users during a continuing interaction or communication of the robot with a user or a group of users.
20. The method of clause 19, wherein the robot like default personality of clause 5 may still perform functionally useful tasks as performed by a robot for a user or a group of users, wherein during the same continuing interaction or communication, the user or the group of users are also entertained by the human like personalities of clause 19.
21. The method of clause 19, wherein the robot like default personality of clause 5 and human like personalities of clauses 4 and 6 may work together in tandem, without any limitation, to take part in routines to tell jokes, express happy or sad emotions, sing songs, play music, make encouraging remarks, make spiritual or inspirational remarks, make wise-cracking remarks, perform spontaneous and recorded comedic routines and do typical robotic functional tasks, without any limitation, for the entertainment of a user or a group of users configured to interact with the robot.
22. The method of clause 21, wherein the human like and default robot like personalities of clauses 4-6, respectively, may work together in tandem to interact and communicate with a user or a group of users for entertainment, education, training, greeting, guiding, customer service and any other purpose, without any limitation, wherein the default robot like personality my still perform functionally useful robotic tasks.
23. The method of clause 22, where the human like and default robot like personalities of clauses 4-6 implemented in animated multiple interactive personality (AMIP) chat- and chatter-bots software versions configured to interact with a user or a group of users through web- or mobile interfaces and devices supporting them.
24. The method of clause 23, wherein AMIP chat- and chatter-bots interact with a user with human like personality traits in a “human like” manner, while also interact with a user with robot like personality traits in a robot like manner during a continuing interaction or conversation with a user through web- or mobile-interfaces and devices supporting them.
25. The method of clause 23, wherein the web- and mobile version of AMIP chat and chatter-bots interact or communicate with remotely located user or group of users to collect data from users including, but not limited to, user contact, gender, age-group, income group, education, geolocation, interests, likes and dislikes, as well as user's questions, comments, scenarios and feed-back etc., on the AMIP chat- and chatter-bot responses within a web- and mobile-based crowd sourcing environment.
26. The method of clause 25, wherein data collected from remotely connected users interacting with AMIP chat- and chatter-bots through web- and mobile-based crowd sourcing environment is used for creating default multiple interactive personalities, and customization of the multiple interactive personalities as according to user's preferences via interactive feedback loops. The customized personalities as according to user's preferences are then available for download and use as multiple interactive personalities robots made using the method of clause 1.
27. The method of clause 25, wherein the ratio of human like responses and the robot like response by AMIP chat- and chatter-bots to remotely located users via web- and mobile interfaces in a crowd sourcing environment are adjusted using a suitable algorithm, without any limitation, using a feedback loop to customized the multiple interactive personalities in AMIP chat- and chatter-bots according to user's preferences. The customized personalities as according to user's preferences are then available for download and use as multiple interactive personalities robots made using the method of clause 1.
28. A robotic apparatus system, capable of exhibiting two or more than two personality types of clause 1, comprising of:

a physical robot apparatus system;

a central processing unit (cpu);

sensors that collect input data from users within the interaction range of the robot;

controllers to control the head, facial, eyes, eyelids, lips, mouth, and base movements of the robot;

wired or wireless capability to connect with internet, mobile, cloud computing system, other robots with ports to connect with key-board, USB, HDMI cable, a personal computer, mobile smart phone, tablet computer, telephone line, wireless mobile, Ethernet cable, and Wi-Fi connection;

touch sensitive or non-touch sensitive display connected to keyboard, mouse, game controllers via suitable ports;

PCI slot for single or multiple carrier SIM card to connect with direct wireless mobile data line for data and VOIP communication;

onboard battery or power system with wired and inductive charging stations; and

memory including the stored previous data related to the personalities of the robot as well as the instructions to be executed by the processor to process the collected input data for the robot to perform the following functions without any limitations:

obtain information from the sensor input data;

determine which one of the multiple personality types will respond determine the manner and type of the response;

execute the response by the robot without any overlap or conflict between multiple personalities;

store the information related to changing the multiple personalities of the robot change any one or all stored multiple personalities of the robot;

delete a stored previous personality of the robot; and

create a new personality of the robot.

29. The robotic system of clause 28, wherein the input data, with in the vicinity or the interaction range including the robot and a user or a group of users, comprises:

one or more communicated characters, words, and sentences relating to written and spoken communication between a user and the robot;

one or more communicated images, lights, videos relating to visual and optical communication between a user and the robot;

one or more communicated sound related to the communication between a user and the robot; and

one or more communicated touch related to the communication between a user and the robot, to communicate the information related to determining the previous mood of the user or a group of users as according to clause 1.

30. A computer readable medium with stored executable instructions of clause 28, that when executed by a computer apparatus, cause the computer apparatus to perform the method of clause 1 to receive input data, process the data to provide information to the robot apparatus to choose one of the two or more than two interactive personalities for the robot to respond and communicate with a user or a group of users.

Still further, while certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions.

As used in this specification and claims, the terms “for example,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation.

What is claimed is:

1. A method for providing one or more than one personality type to a robot, wherein the method comprises:
providing a robot with a capability to speak in one or more than one voice type, accent, language, and emotion accompanied with a suitable facial expression to exhibit one or more than one interactive personality type, wherein the robot is capable of switching back and forth among different personality types during a continuing interaction or communication with a user;
providing the robot with a capability to ask direct questions and obtain additional information using a connection device and at least one of sound, speech, or facial recognition sensors on the robot, wherein the additional information relates to the continuing interaction or communication with the user; and
providing the robot with a capability to process the additional information to generate data to enable the robot to respond and speak in any of the one or more than one voice type, accent, language and emotion with the suitable facial expression, wherein the processing of the additional information occurs onboard within the robot for a faster speed and instantaneous response by the robot to the user without any overlap or conflict between the different personality types.

2. The method of claim 1, wherein the one or more than one voice type comprises at least one default synthesized digital voice or computer-generated synthetic voice to exhibit at least one robot personality.

3. The method of claim 2, wherein the one or more than one voice type comprises at least one digitally recorded human voice to exhibit at least one human personality.

4. The method of claim 3, further comprising:
providing the robot with a capability to ask questions and express emotions using the at least one digitally recorded human voice during the continuing interaction or communication with the user; and
providing the robot with a capability to speak in the at least one default synthesized digital voice during the same continuing interaction or communication with the user.

5. The method of claim 4, further comprising
providing the robot with a capability to respond, using the at least one default synthesized digital voice, with artificial intelligence learned and analyzed facts and figures without exhibiting any emotions or asking any questions.

6. The method of claim 3, wherein the one or more than one voice type comprises at least one computer synthesized voice engineered to mimic the human voice of a specific person or personality to exhibit a human personality associated with the specific person or personality.

7. The method of claim 1, wherein the one or more than one language comprises at least one of English, French, Spanish, German, Portuguese, Chinese-Mandarin, Chinese-Cantonese, Korean, Japanese, Hindi, Urdu, Punjabi, Bengali, Gujrati, Marathi, Tamil, Telugu, Malayalam, or Konkani.

8. The method of claim 7, wherein the one or more than one accent comprises a localized speaking style or dialect associated with the one or more than one language.

9. The method of claim 1, wherein the one or more than one emotion comprises spoken words or speech including variations in at least one of tone, pitch, or volume to represent emotions associated with at least one digitally recorded human voice.

10. The method of claim 1, further comprising:
providing the robot with a capability to vary at least one of a shape of its eyes, a color of its eyes, a position of its eyelids, or a position of its head in relation to its torso to generate the accompanying suitable facial expression.

11. The method of claim 1, further comprising:
providing the robot with a capability, via miniature LED lights, to vary a shape of its mouth and lips to generate the accompanying suitable facial expression.

12. The method of claim 1, further comprising:
providing the robot with a capability to perform one or more than one hand movement or gesture to accompany the one or more than one interactive personality type.

13. The method of claim 1, further comprising:
providing, for multiple of the different personality types, the robot with a capability to move within an interaction range or communication range of the user or a group of users, wherein the group of users interact with each other and with the robot.

14. The method of claim 1, wherein the robot is configured to interact with an ambient environment without the user or a group of users present within the ambient environment.

15. The method of claim 1, wherein the robot is configured to interact with another robot within an ambient environment without the user or a group of users present within the ambient environment.

16. The method of claim 1, wherein the robot is configured to interact with another robot within an ambient environment with the user or a group of users present in the ambient environment.

17. The method of claim 1, wherein the connection device comprises at least one of a key-board, a touch screen, an HDMI cable, a personal computer, a mobile smart phone, a tablet computer, a telephone line, a wireless mobile, an Ethernet cable, or a Wi-Fi connection.

18. The method of claim 3, wherein the at least one human personality is based on one or more than one of:
context associated with a local geographical location, local weather, and a local time of day; or
recorded historical information associated with the user or a group of users configured to interact with the robot.

19. The method of claim 3, further comprising:
providing the robot with a capability, for the at least one human personality, to at least one of tell jokes, express happy or sad emotions, sing songs, play music, make encouraging remarks, make spiritual or inspirational remarks, make wise-cracking remarks, or perform spontaneous or recorded comedic routines for the user or a group of users during the continuing interaction or communication of the robot with the user or the group of users.

20. The method of claim 19, further comprising:
providing the robot with a capability, for the at least one robot personality, to respond with artificial intelligence learned and analyzed facts and figures without exhibiting any emotions or asking any questions such that the at least one robot personality performs functionally useful tasks for the user or the group of users during the same continuing interaction or communication with the user or the group of users.

21. The method of claim 20, further comprising:
providing the robot with a capability to switch back and forth between the at least one human personality and the at least one robot personality such that the at least one human personality and the at least one robot personality work together in tandem during the same continuing interaction or communication with the user or the group of users.

22. The method of claim 20, further comprising
providing the robot with a capability to switch back and forth between the at least one human personality and the at least one robot personality such that the at least one human personality and the at least one robot personality work together in tandem to at least one of entertain, educate, train, greet, guide, or provide customer service to the user or the group of users during the same continuing interaction or communication with the user or the group of users.

23. The method of claim 22, wherein the robot is an animated multiple interactive personality (AMIP) chat-bot or a chatter-bot provided via AMIP chat-bot or chatter-bot software, and wherein the user or the group of users interact or communicate with the AMIP chat-bot or chatter bot through a web-interface device or a mobile-interface device.

24. The method of claim 23, wherein the AMIP chat-bot or chatter-bot interacts with the user or the group of users using the at least one human personality in a human manner and the at least one robot personality in a robot manner during the continuing interaction or communication with the user or the group of users through the web-interface or the mobile-interface.

25. The method of claim 23, wherein the user or the group of users are remotely located, and wherein the additional information comprises one or more than one of user contact, gender, age group, income group, education, geolocation, interests, likes, dislikes, user questions, user comments, scenarios, and feed-back on responses within a web-based or mobile-based crowd sourcing environment.

26. The method of claim 25, further comprising:
using the additional information to:
create multiple interactive personality types; and
customize the multiple interactive personality types based on user preferences via an interactive feedback loop; and
making the customized multiple interactive personality types available for download and use in an AMIP chat-bot or chatter-bot.

27. The method of claim 23, further comprising:
using an algorithm to adjust a ratio of responses made in a human manner via the at least one human personality to responses made in a robot manner via the at least one robot personality;
using a feedback loop to customize multiple interactive personality types; and
making the customized multiple interactive personality types available for download and use in an AMIP chat-bot or chatter-bot.

28. A robotic system, capable of exhibiting two or more than two personality types, the robotic system comprising:
a physical robot, comprising:
a central processing unit;
at least one sensor that collects input data from a user within an interaction range of the robot, wherein the at least one sensor comprises one or more of a sound, speech, and facial recognition sensor;
at least one controller to control a head, a face, eyes, eyelids, lips, a mouth, and base movements of the robot;
a wired or wireless network connection configured to connect with at least one of an internet, a mobile system, a cloud computing system, or another robot;
at least one port configured to connect one or more of a key-board, a USB, a HDMI cable, a personal computer, a mobile smart phone, a tablet computer, a telephone line, a wireless mobile device, an Ethernet cable, and a Wi-Fi connection;
a touch sensitive or non-touch sensitive display;
a PCI slot for a single or a multiple carrier SIM card to connect with a direct wireless mobile data line for data and VOIP communication;
an onboard battery or power system configured for wired and inductive charging stations;
a memory including previously stored data related to personalities of the robot and software instructions executable by the central processing unit to perform functions including:
asking questions to obtain additional information via one or more of the at least one sensor and the at least one port, wherein the additional information relates to a continuing interaction or communication with the user;
determining which one of multiple different personality types will respond during the continuing interaction or communication with the user, wherein each different personality type is exhibited by a voice type, accent, language, and emotion accompanied by a suitable facial expression;
determining a manner and a type of the response;
executing the response in the determined voice type, accent, language and emotion accompanied by the suitable facial expression without any overlap or conflict between the multiple different personality types; and
administering the multiple different personality types, wherein the administering includes:
storing information related to a change in any of the multiple different personality types;
deleting a previously stored personality type; and
creating a new personality type.

29. A robotic system of claim 28, wherein the additional information comprises at least one of:
one or more communicated characters, words, and sentences relating to written and spoken communication between the user and the robot;
one or more communicated images, lights, videos relating to visual and optical communication between the user and the robot;
one or more communicated sound related to the communication between the user and the robot; or
one or more communicated touch related to the communication between the user and the robot;
wherein the additional information is used to determine a mood of the user to determine the manner and the type of the response.

30. A computer readable medium storing executable instructions that when executed by a computer processor of a robot, cause the computer processor to:
receive input data comprising additional information related to a continuing interaction or communication between the robot and a user;
process the additional information to determine one of two or more than two interactive personality types of the robot to respond to the user during the continuing interaction or communication, wherein each interactive personality type is exhibited by a voice type, accent, language, and emotion accompanied by a suitable facial expression; and
respond to the user using the determined interactive personality type without any overlap or conflict between the interactive personality types of the robot.
